(19) United States
(12) Patent Application Publication
(10) Pub. No.: US 2025/0154059 A1
(43) Pub. Date: May 15, 2025

(54) LOW-ALKALI ACCELERATOR AND PREPARATION METHOD

(71) Applicants: CHINA RAILWAY NO.4 ENGINEERING GROUP CO., LTD, Anhui (CN); ANHUI ENGINEERING MATERIAL TECHNOLOGY CO, LTD OF CTCE GROUP, Anhui (CN); YUNNAN CHINA RAILWAY NEW MATERIALS TECHNOLOGY CO., LTD, Yunnan (CN)

(72) Inventors: Dongdong FAN, Anhui (CN); Chunhong LIN, Anhui (CN); Zongjian ZHU, Anhui (CN); Zhiyong WANG, Anhui (CN); Hai HUANG, Anhui (CN); Zhenghui XIA, Anhui (CN); Shuangchao LI, Anhui (CN); Zhonghan WANG, Anhui (CN); Yafei ZHANG, Anhui (CN)

(73) Assignees: CHINA RAILWAY NO.4 ENGINEERING GROUP CO., LTD, Anhui (CN); ANHUI ENGINEERING MATERIAL TECHNOLOGY CO, LTD OF CTCE GROUP, Anhui (CN); YUNNAN CHINA RAILWAY NEW MATERIALS TECHNOLOGY CO., LTD, Yunnan (CN)

(21) Appl. No.: 19/021,057

(22) Filed: Jan. 14, 2025

Related U.S. Application Data
(63) Continuation of application No. PCT/CN2024/089389, filed on Apr. 23, 2024.

(30) Foreign Application Priority Data
Jun. 9, 2023 (CN) 202310682303.5

(51) Int. Cl. C04B 14/04

(52) U.S. Cl. CPC C04B 14/043; C04B 14/045

(57) ABSTRACT

A low-alkali accelerator and a preparation method therefor are provided. The preparation method comprises: S1, preparing a sodium metaaluminate solution; S2, adding water to the sodium metaaluminate solution, stirring same until uniform, then adding aluminum sulfate thereto, and reacting same at 50-80° C. for 0.5-1 h under stirring conditions; S3, within 10-30 min after complete reaction of the aluminum sulfate, adding, in a dropwise manner, a regulator to regulate the pH value to a neutral state; S4, mixing a strong-alkali weak-acid salt and a silicon dioxide gel until uniform, then adding same to a fluoride salt, and mixing same until uniform, to obtain a modified fluoride salt; and adding the modified fluoride salt to a neutral solution obtained in S3, and reacting same for 1-1.5 h, with the temperature maintained at 50-80° C.; and S5, adding an organic alcohol amine thereto, and stirring same for 0.5-1 h, to obtain the low-alkali accelerator.

### CROSS REFERENCE TO RELATED APPLICATIONS

The present application is a continuation application of international PCT application serial no. PCT/CN2024/089389, filed on Apr. 23, 2024, which claims the priority of the Chinese patent with the Application No. 202310682303.5, filed with China National Intellectual Property Administration on Jun. 9, 2023, and entitled “Low-alkali accelerator and preparation method”, which is incorporated in its entirety herein by reference.

### TECHNICAL FIELD

The present disclosure relates to the technical field of concrete processing, and specifically relates to a low-alkali accelerator and a preparation method therefor.

### BACKGROUND

An accelerator is one of essential raw materials for preparation of concrete, and the accelerator is capable of enhancing an early strength of concrete and increasing shrinkage of mortar and cement. By alkali content, accelerators commonly used in cement concrete can be divided into alkaline accelerators or low-alkali accelerators. The alkaline accelerators have high alkali content and are highly corrosive, corrode construction machinery and tools during production and construction, and may endanger human health. Therefore, the alkaline accelerators are being replaced by the low-alkali accelerators.

However, in actual use, it has been found that the low-alkali accelerators have poor storage stability, thereby affecting promotion and use thereof.

### SUMMARY

### (1) Technical Problems to be Solved

In order to overcome the defects of the prior art, the present disclosure provides a low-alkali accelerator and a preparation method therefor, and solves the technical problem of poor storage stability of low-alkali accelerators of the prior art.

### (2) Technical Solution

In order to achieve the above objective, the present disclosure is achieved by the following technical solution:

A preparation method for a low-alkali accelerator, including the following steps:
S1, preparing a sodium metaaluminate solution;
S2, adding water to the sodium metaaluminate solution, stirring same until uniform, then adding aluminum sulfate thereto, and reacting same at 50-80° C. for 0.5-1 h under stirring conditions;
S3, within 10-30 min after complete reaction of the aluminum sulfate, adding, in a dropwise manner, a regulator to regulate the pH value to a neutral state;
S4, mixing a strong-alkali weak-acid salt and a silicon dioxide gel until uniform, then adding same to a fluoride salt, and mixing same until uniform, so as to obtain a modified fluoride salt; and adding the modified fluoride salt to a neutral solution obtained in S3, and reacting same for 1-1.5 h, with the temperature maintained at 50-80° C.; and
S5, adding an organic alcohol amine thereto, and stirring same for 0.5-1 h, so as to obtain the low-alkali accelerator.

Preferably, the silicon dioxide gel is hydrophilic.

Preferably, a specific surface area of the silicon dioxide gel is 600-800 m²/g.

Preferably, the sodium metaaluminate solution includes sodium hydroxide and aluminum hydroxide, and a mass ratio of the sodium hydroxide to the aluminum hydroxide is 1:2.5-3.5.

In a further aspect, a low-alkali accelerator prepared by the preparation method is provided, and the low-alkali accelerator includes the following components in percentage by weight:
sodium metaaluminate: 7-16%;
aluminum sulfate: 35-40%;
a modifier: 1-5%;
a fluorine salt: 4-10%;
organic alcohol amine: 5-10%;
water: 20-36%;
a sum of all the components: 100%; and
the modifier includes: a strong-alkali weak-acid salt and a silicon dioxide gel, and a mass ratio of the strong-alkali weak-acid salt to the silicon dioxide gel is 2-4:1.

Preferably, the strong-alkali weak-acid salt includes at least one of sodium carbonate, sodium bicarbonate, potassium carbonate, sodium sulfite, sodium acetate, sodium sulfide, and sodium phosphate.

Preferably, the fluoride salt includes at least one of sodium fluoride, sodium fluorosilicate and magnesium fluorosilicate.

Preferably, the fluoride salt includes sodium fluoride, sodium fluorosilicate, and magnesium fluorosilicate.

Preferably, a mass ratio of the sodium fluoride to the sodium fluorosilicate and to the magnesium fluorosilicate is (1-2):(5-7):(2-3).

Preferably, a mass ratio of the sodium fluoride to the sodium fluorosilicate and to the magnesium fluorosilicate is 1.5:6:2.5.

### (3) Beneficial Effects

The present disclosure provides a low-alkali accelerator and a preparation method therefor. Compared to the prior art, the present disclosure has the following beneficial effects:

The preparation method for a low-alkali accelerator provided in the present disclosure includes: first adding a sodium metaaluminate solution and aluminum sulfate, regulating a pH value to a neutral state, adding a modified fluoride salt, where a modifier includes a strong-alkali weak-acid salt, and hydrolyzing the strong-alkali weak-acid salt under neutral conditions, where hydrolysis of the strong-alkali weak-acid salt further promotes the hydrolysis of fluoride salt, and the hydrolysis of fluoride salt causes generation of fluoride ions and a silicon dioxide gel. In a prepared low-alkali accelerator system, the generated silicon dioxide gel encapsulates the fluoride ions and aluminum ions in the system, which weakens a probability of combining the fluoride ions and the aluminum ions, thereby avoiding generation of aluminum fluoride crystals during storage and slow agglomeration into large particles. Therefore, crystals will not be produced during storage of the prepared low-alkali accelerator, with good storage stability. The modifier further includes silicon dioxide gel, and the silicon dioxide gel further encapsulates fluoride ions and chloride ions, which improves the storage stability of the low-alkali accelerator during storage.

### BRIEF DESCRIPTION OF THE DRAWINGS

In order to more clearly describe the technical solutions in the embodiments of the present disclosure or in the prior art, a brief introduction to the accompanying drawings required for the description of the embodiments or the prior art will be made below. Apparently, the accompanying drawings in the following description are merely some embodiments of the present disclosure, and those of ordinary skill in the art would also be able to derive other drawings from these drawings without making creative efforts.

FIG. 1 is a state diagram of a low-alkali accelerator prepared in Example 1 after storage for 90 d.

FIG. 2 is a state diagram of a low-alkali accelerator prepared in Comparative Example 1 after storage for 3 d.

FIG. 3 is a state diagram of a low-alkali accelerator prepared in Comparative Example 2 after storage for 5 d.

FIG. 4 is a state diagram of a low-alkali accelerator prepared in Comparative Example 3 after storage for 5 d.

### DETAILED DESCRIPTIONS OF THE EMBODIMENTS

In order to make the objectives, technical solutions and advantages of the examples of the present disclosure clearer, the technical solutions in the examples of the present disclosure will be clearly and completely described. Apparently, the examples described are merely some rather than all of the examples of the present disclosure. Based on the examples of the present disclosure, all other examples acquired by those of ordinary skill in the art without making creative efforts fall within the scope of protection of the present disclosure.

The present disclosure, by providing a low-alkali accelerator and a preparation method therefor, solves the technical problem of poor storage stability of low-alkali accelerators of the prior art.

In order to solve the above problem, the general idea of the technical solution in an example of the present disclosure is as follows:

During preparation of a low-alkali accelerator, fluoride salt is first modified with strong-alkali weak-acid salt and silicon dioxide gel, and then the modified fluoride salt is used to prepare a low-alkali accelerator system. The modified fluoride salt is used to prepare the low-alkali accelerator, the strong-alkali weak-acid salt promotes hydrolysis of sodium fluorosilicate to generate silicon dioxide gel, and the newly generated silicon dioxide gel and the silicon dioxide gel in a modifier can respectively encapsulate fluoride ions and chloride ions in the low-alkali accelerator system, which weakens a probability of combining the fluoride ions and the aluminum ions, thereby avoiding generation of small aluminum fluoride particles during storage and slow agglomeration into large particles, and improving storage stability of the low-alkali accelerator during storage.

The modifier further includes silicon dioxide gel, and the silicon dioxide gel further encapsulates the fluoride ions and the chloride ions, which improves the storage stability of the low-alkali accelerator during storage. Especially in an early stage of hydrolysis of the fluoride salt, silicon dioxide gel produced by the hydrolysis is less, and the silicon dioxide gel is capable of better encapsulating the fluoride ions produced by the hydrolysis, which blocks contact between the fluoride ions and the chloride ions, and ensures that the small aluminum fluoride particles are not generated during the preparation process.

In the early stage of hydrolysis of the fluoride salt, the silicon dioxide gel in the modifier is also capable of inhibiting the hydrolysis of fluoride salt and reducing a hydrolysis rate so as to avoid generation of the small aluminum fluoride particles from a combination of a lot of the fluoride ions and the aluminum ions due to excessively fast hydrolysis, thereby preventing generation of particulate matters in a process of preparing the low-alkali accelerator.

In order to better understand the above technical solution, the above technical solution will be described in detail below with reference to the accompanying drawings and specific implementations.

### Example 1

In this example, a preparation method for a low-alkali accelerator is provided, including the following steps:
S1, take an appropriate amount of water, and prepare a sodium metaaluminate solution by mixing sodium hydroxide and aluminum hydroxide in a mass ratio of 1:2.5;
S2, add an appropriate amount of water to the sodium metaaluminate solution, stir same until uniform, then add aluminum sulfate to the above system at one time, start stirring and heating, set a reaction temperature to 60° C., and react same for 0.5 h with the temperature maintained;
S3, within 10 min after a complete reaction of the aluminum sulfate, add, in a dropwise manner, a regulator to the above system to regulate a pH value to a neutral state;
S4, use a stirring device to mix sodium carbonate and hydrophilic silicon dioxide gel until uniform in a mass ratio of 2:1 to obtain a modifier, and then add the modifier to sodium fluorosilicate, and mix same until uniform to obtain modified sodium fluorosilicate;
a specific surface area of the silicon dioxide gel is 600 m²/g;
add the modified sodium fluorosilicate to a neutral solution in the S3, and react same for 1 h with a temperature maintained at 60° C.; and
S5, stop heating, add an organic alcohol amine thereto, and stir same for 0.5 h, so as to obtain the low-alkali accelerator.

Particulate matters are not produced in the process of preparing the low-alkali accelerator.

The low-alkali accelerator prepared includes the following components in percentage by weight:
sodium metaaluminate: 9%;
aluminum sulfate: 40%;
a modifier: 3%;
sodium fluorosilicate: 7%;
organic alcohol amine: 5%; and
water: 36%.

### Example 2

In this example, a preparation method for a low-alkali accelerator is provided, including the following steps:
S1, prepare a sodium metaaluminate solution by mixing sodium hydroxide and aluminum hydroxide in a mass ratio of 1:3;
S2, add water to the sodium metaaluminate solution, stir same until uniform, then add aluminum sulfate to the above system at one time, start stirring and heating, set a reaction temperature to 70° C., and react same for 0.8 h with the temperature maintained;
S3, within 20 min after a complete reaction of the aluminum sulfate, add, in a dropwise manner, a regulator to the above system to regulate a pH value to a neutral state;
S4, use a stirring device to mix sodium bicarbonate and silicon dioxide gel until uniform in a mass ratio of 3:1 to obtain a modifier, and then add the modifier to magnesium fluorosilicate, and mix same until uniform to obtain modified magnesium fluorosilicate;
the silicon dioxide gel is hydrophilic, and has a specific surface area of 700 m²/g;
add the modified magnesium fluorosilicate to a neutral solution in the S3, and react same for 1.2 h with a temperature maintained at 70° C.; and
S5, stop heating, add an organic alcohol amine thereto, and stir same for 0.8 h, so as to obtain the low-alkali accelerator.

Particulate matters are not produced in the process of preparing the low-alkali accelerator.

The low-alkali accelerator prepared includes the following components in percentage by weight:
sodium metaaluminate: 13%;
aluminum sulfate: 35%;
a modifier: 4%;
magnesium fluorosilicate: 5%;
organic alcohol amine: 7%; and
water: 36%.

### Example 3

In this example, a preparation method for a low-alkali accelerator is provided, including the following steps:
S1, prepare a sodium metaaluminate solution by mixing sodium hydroxide and aluminum hydroxide in a mass ratio of 1:3.5;
S2, add water to the sodium metaaluminate solution, stir same until uniform, then add aluminum sulfate to the above system at one time, start stirring and heating, set a reaction temperature to 80° C., and react same for 1 h with the temperature maintained;
S3, within 30 min after a complete reaction of the aluminum sulfate, add, in a dropwise manner, a regulator to the above system to regulate a pH value to a neutral state;
S4, use a stirring device to mix potassium carbonate and silicon dioxide gel until uniform in a mass ratio of 4:1, then add same to the fluoride salt, and mix same until uniform to obtain a modified fluoride salt, where the fluoride salt includes sodium fluoride, sodium fluorosilicate, and magnesium fluorosilicate, and a mass ratio of the sodium fluoride to the sodium fluorosilicate and to the magnesium fluorosilicate is 1.5:6:2.5.

The silicon dioxide gel is hydrophilic, and has a specific surface area of 800 m²/g;
add the modified fluoride salt to a neutral solution in the S3, and react same for 1.5 h with a temperature maintained at 80° C.; and
S5, stop heating, add an organic alcohol amine thereto, and stir same for 1 h, so as to obtain the low-alkali accelerator.

Particulate matters are not produced in the process of preparing the low-alkali accelerator.

The low-alkali accelerator prepared includes the following components in percentage by weight:
sodium metaaluminate: 16%;
aluminum sulfate: 38%;
a modifier: 5%;
a fluorine salt: 10%;
organic alcohol amine: 10%; and
water: 21%.

### Comparative Example 1

The difference between this comparative example and Example 1 lies in that sodium fluorosilicate is not modified, and the sodium fluorosilicate is directly added to a neutral solution in the S3, and all other aspects are the same as Example 1.

Particulate matters are produced in a process of preparing.

### Comparative Example 2

The difference between this comparative example and Example 1 lies in that only sodium carbonate is used to modify sodium fluorosilicate, and all other aspects are the same as Example 1.

Particulate matters are not contained in a prepared low-alkali accelerator.

### Comparative Example 3

The difference between this comparative example and Example 1 lies in that only silicon dioxide gel is used to modify sodium fluorosilicate, and all other aspects are the same as Example 1.

Particulate matters are not contained in a prepared low-alkali accelerator.

Storage stability of the low-alkali accelerators prepared in Examples 1-3 and Comparative Examples 1-3 is tested, and test results are shown in Table 1.

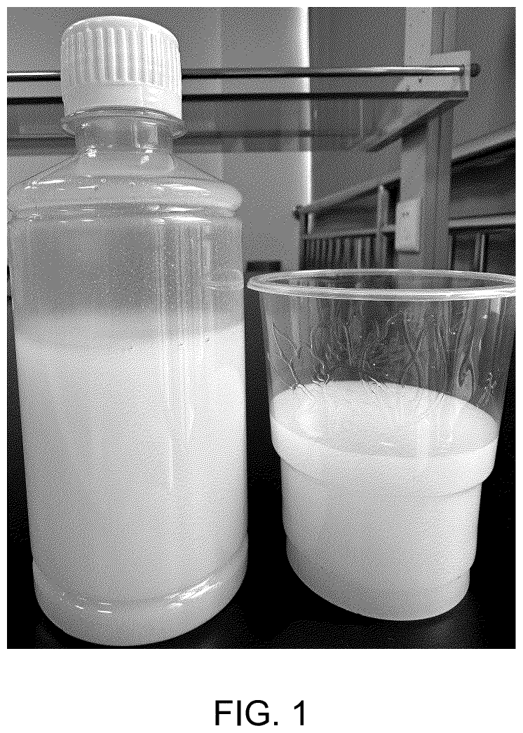

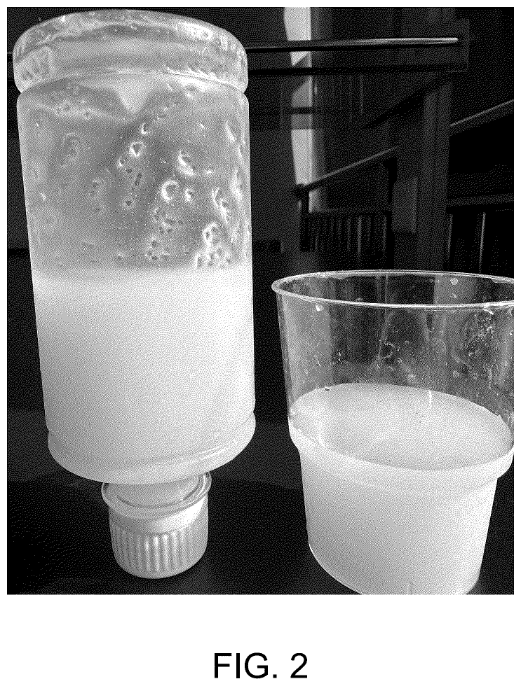

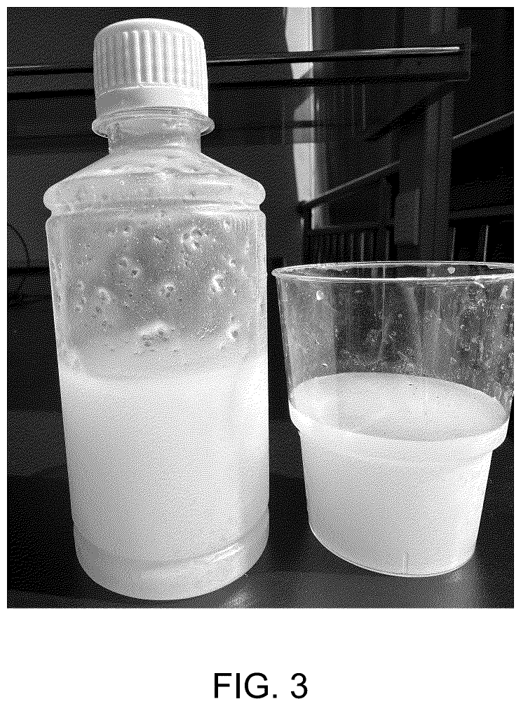

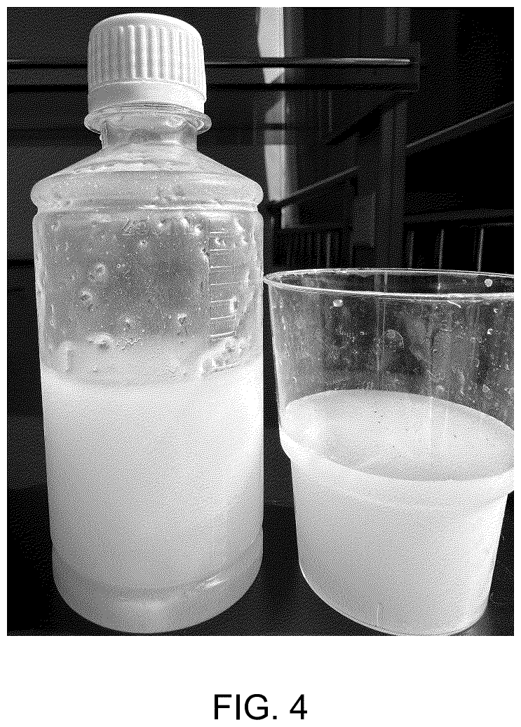

Storage stability test method: store a prepared low-alkali accelerator at normal temperature and pressure, observe whether obvious crystals exist in a low-alkali accelerator system after letting same stand for a certain period of time, and record time, where longest standing time is 90 d. FIG. 1 illustrates a state of a low-alkali accelerator prepared in Example 1 after storage for 90 d, without obvious crystallization. FIG. 2 illustrates a state of a low-alkali accelerator prepared in Comparative Example 1 after storage for 3 d, with obvious crystallization. FIG. 3 illustrates a state of a low-alkali accelerator prepared in Comparative Example 2 after storage for 5 d, with obvious crystallization. FIG. 4 illustrates a state of a low-alkali accelerator prepared in Comparative Example 3 after storage for 5 d, with obvious crystallization.

TABLE 1
Storage stability test results of low-alkali accelerators prepared

| Low-alkali accelerators | Time of obvious crystallization |
|---|---|
| Example 1 | No obvious crystallization |
| Example 2 | No obvious crystallization |
| Example 3 | No obvious crystallization |
| Comparative Example 1 | 3 d |
| Comparative Example 2 | 5 d |
| Comparative Example 3 | 5 d |

It can be seen from Table 1 that the low-alkali accelerator prepared by modifying a fluoride salt with a strong-alkali weak-acid salt and silicon dioxide gel and then adding same to the system exhibits good stability, without obvious crystallization within 90 d; and the low-alkali accelerator prepared by adding the fluoride salt directly to the system without modification exhibits obvious crystallization after 3 d, indicating that modifying the fluorine salt with the strong-alkali weak-acid salt and the silicon dioxide gel can improve stability of the low-alkali accelerator. However, the low-alkali accelerators prepared by modifying the fluoride salt with only the strong-alkali weak-acid salt or the silicon dioxide gel also exhibits obvious crystallization respectively after 5, maybe because the storage stability of the low-alkali accelerator can be further enhanced only through a synergistic effect of the strong-alkali weak-acid salt and the silicon dioxide gel.

According to the standard GB/T 35159-2017 Flash Setting Admixtures for Shotcrete, the low-alkali accelerators prepared in Examples 1-3 and Comparative Examples 1-3 after storage for 5 d are added to cement paste, where a weight of an accelerator accounts for 4% or 6% of that of cement, and setting time of the cement paste and a compressive strength of cement mortar are tested, as shown in Table 2.

A ratio of testing the cement paste setting time: reference cement:water=400:140.

A ratio of testing the compressive strength of cement mortar: reference cement:standard sand:water=900:1350:450.

TABLE 2
Setting time and compressive strength test results

| | | | | Compressive strength | |
|---|---|---|---|---|---|
| | | | | of cement mortar | |
| | | Cement paste | | 1 d | 28 d |
| | | setting time | | compressive | compressive |
| Low-alkali | | Initial | Final | strength/ | strength |
| accelerators | | setting | setting | Mpa | ratio/% |
| Example 1 | 4% | 3 min 15 s | 6 min | 9.4 | 101.4 |
| | 6% | 1 min 35 s | 2 min 45 s | 12.7 | 98.6 |
| Example 2 | 4% | 3 min 10 s | 6 min 05 s | 10.2 | 98.7 |
| | 6% | 1 min 35 s | 2 min 30 s | 13.5 | 97.5 |
| Example 3 | 4% | 2 min 10 s | 4 min 10 s | 12.5 | 95.9 |
| | 6% | 1 min 05 s | 2 min | 14.1 | 93.1 |
| Comparative | 4% | 6 min 15 s | 12 min 30 s | 3.2 | 76.5 |
| Example 1 | 6% | 5 min 10 s | 10 min 45 s | 5.7 | 82.4 |
| Comparative | 4% | 4 min 30 s | 8 min 45 s | 5.4 | 86.6 |
| Example 2 | 6% | 3 min 35 s | 7 min 25 s | 6.2 | 88.4 |
| Comparative | 4% | 5 min 05 s | 9 min | 5.9 | 84.3 |
| Example 3 | 6% | 3 min 55 s | 8 min 15 s | 6.1 | 88.2 |

It can be seen from Table 2 that the low-alkali accelerators prepared in Examples 1-3 are used in cement paste or cement mortar, and are superior to the low-alkali accelerators prepared in Comparative Examples 1-3 in terms of the setting time and the compressive strength, because the low-alkali accelerator prepared by modifying the fluoride salt with the strong-alkali weak-acid salt and the silicon dioxide gel and then adding same to the system exhibits good stability, and when the low-alkali accelerator is added to the cement paste or the cement mortar, a large amount of active ingredients can play a role in accelerating the setting.

It is to be explained that the relation terms, for example, first, second, etc., are used herein merely for distinguishing one entity or operation from another entity or operation but do not necessarily require or imply that there exists any actual relation or sequence between these entities or operations. Furthermore, terms “comprising”, “including” or any other variants are intended to cover the non-exclusive including, thereby making that the process, method, object or apparatus comprising a series of elements comprise not only those elements but also other elements that are not listed explicitly or the inherent elements to the process, method, merchandise or apparatus. Without more restrictions, the elements defined by the sentence “including a . . . ” do not exclude the existence of other identical elements in the process, method, article, or device including the elements.

Finally, it should be noted that the above examples are only used to illustrate the technical solutions of the present disclosure, but not to limit them; although the present disclosure has been described in detail with reference to the foregoing examples, those ordinarily skilled in the art should understand that: the technical solutions described in the foregoing examples can still be modified, or some technical features thereof can be equivalently replaced; and these modifications or replacements do not make the essence of the corresponding technical solutions deviate from the spirit and scope of the technical solutions of the examples of the present disclosure.

What is claimed is:

1. A preparation method for a low-alkali accelerator, comprising the following steps:
S1, preparing a sodium metaaluminate solution;
S2, adding water to the sodium metaaluminate solution, stirring same until uniform, then adding aluminum sulfate thereto, and reacting same at 50-80° C. for 0.5-1 h under stirring conditions;
S3, after complete dissolution of the aluminum sulfate, regulating a pH value to a neutral state, to obtain a neutral solution;
S4, mixing a strong-alkali weak-acid salt and a silicon dioxide gel until uniform, then adding same to a fluoride salt, and mixing same until uniform, so as to obtain a modified fluoride salt; and adding the modified fluoride salt to the neutral solution, and reacting same for 1-1.5 h, with a temperature maintained at 50-80° C.; and
S5, adding an organic alcohol amine thereto, and stirring same for 0.5-1 h, so as to obtain the low-alkali accelerator.

2. The preparation method according to claim 1, wherein the silicon dioxide gel is hydrophilic.

3. The preparation method according to claim 1, wherein a specific surface area of the silicon dioxide gel is 600-800 m²/g.

4. The preparation method according to claim 1, wherein the sodium metaaluminate solution comprises sodium hydroxide and aluminum hydroxide, and a mass ratio of the sodium hydroxide to the aluminum hydroxide is 1:2.5-3.5.

5. A low-alkali accelerator, comprising the following components in percentage by weight:
sodium metaaluminate: 7-16%;
aluminum sulfate: 35-40%;
a modifier: 1-5%;
a fluorine salt: 4-10%;
organic alcohol amine: 5-10%;
water: 20-36%;
a sum of all the components: 100%; and
the modifier comprises a strong-alkali weak-acid salt and silicon dioxide gel, and a mass ratio of the strong-alkali weak-acid salt to the silicon dioxide gel is 2-4:1.

6. The low-alkali accelerator according to claim 5, wherein the strong-alkali weak-acid salt comprises at least one of sodium carbonate, sodium bicarbonate, potassium carbonate, sodium sulfite, sodium acetate, sodium sulfide, and sodium phosphate.

7. The low-alkali accelerator according to claim 5, wherein the fluoride salt comprises at least one of sodium fluoride, sodium fluorosilicate and magnesium fluorosilicate.

8. The low-alkali accelerator according to claim 5, wherein the fluoride salt comprises sodium fluoride, sodium fluorosilicate, and magnesium fluorosilicate.

9. The low-alkali accelerator according to claim 8, wherein a mass ratio of the sodium fluoride to the sodium fluorosilicate and to the magnesium fluorosilicate is (1-2):(5-7):(2-3).

10. The low-alkali accelerator according to claim 8, wherein a mass ratio of the sodium fluoride to the sodium fluorosilicate and to the magnesium fluorosilicate is 1.5:6:2.5.
